(19) United States
(12) Patent Application Publication
(10) Pub. No.: US 2009/0047438 A1
(43) Pub. Date: Feb. 19, 2009

(54) Method and apparatus for forming waterproof film

(76) Inventors: Yoshito Kawata, Hyogo (JP); Hideyuki Tsuchida, Osaka (JP)

Correspondence Address: JORDAN AND HAMBURG LLP, 122 EAST 42ND STREET, SUITE 4000, NEW YORK, NY, 10168, US

(21) Appl. No.: 11/921,699

(22) PCT Filed: Aug. 25, 2005
(86) PCT No.: PCT/JP2005/015417

§ 371 Date: Jan. 9, 2008

(30) Foreign Application Priority Data
Jun. 7, 2005 (JP) 2005-166977

(51) Int. Cl. B05D 1/34; B05C 5/00

(52) U.S. Cl. 427/426; 118/300

(57) ABSTRACT

A method for forming a waterproof film includes: providing a main component container that contains a main component for forming a waterproof film and discharges the main component as a piston is pushed, and a curing agent container that contains a curing agent for the main component and discharges the curing agent as a piston is pushed, the containers being encased in a pair of retainer cases arranged in a parallel arrangement, respectively; pushing the pistons for the main component container and the curing agent container in a synchronized manner by a single, compressed air-driven cylinder device that is arranged adjacent to the pair of retainer cases; through respective supply hoses, feeding the discharged main component and the curing agent to a spouting gun module that is held by an operator and supplied with compressed air; mixing the main component and the curing agent in a static mixer unit in the spouting gun module; and blowing the mixture with the flow of compressed air onto an object to be waterproofed. This method makes it possible to effectively form a waterproof film in a short period of time.

### TECHNICAL FIELD

The present invention relates to a waterproof film forming method and an apparatus that can effectively form a high-quality waterproof film, such as a waterproof urethane film, in a short period of time.

### BACKGROUND ART

One known technique used in the civil engineering and construction industry for waterproofing large-scale surfaces such as floor slabs, roofs of concrete buildings and walls of swimming pools is to blow a mixture of a main component made of a high-speed curable urethane resin and its curing agent onto a surface to be waterproofed to form a waterproof urethane film on the surface. In one known preferred technique of all others, the high-speed curable urethane resin as a main component and its curing agent are individually pressurized and sent to a static mixer unit by a motor-driven gear pump in a controlled amount of flow. The two liquids are mixed in the static mixer unit and, at the discharge port of the static mixer unit, the mixture is combined with a flow of compressed air flowing through an air pathway between the static mixer unit and the outer covering tube. The combined flow of compressed air and the mixture is then spouted from the nozzle port onto a surface to be waterproofed to effectively form a high-quality waterproof urethane film in a single blowing action. The resulting film has a uniform thickness, is permeable to water vapor, but not to water, and has a high adhesive strength (See, for example, Patent Document 1).

In a small-scale caulking process, a cartridge is used that separately contains a high-speed urethane resin as a main component and its curing agent and discharges them by the action of a piston. The cartridge is mounted on a mounting portion of a spouting gun module. Using an air cylinder device of the spouting gun module, the piston of the cartridge is pushed to discharge the two liquids from the cartridge. The two liquids are then mixed in a static mixer unit and the mixture is propelled by a spouting air stream that flows from the periphery of the mixture to the spout orifice. The propelled mixture is blown onto an object to be waterproofed. In this known technique, a high-quality waterproof urethane film can be effectively applied to a small-scale surface to be waterproofed using only the spouting gun module and the compressed air source (See, for example, Patent Document 2).

[Patent Document 1] Japanese Patent No. 3248554

[Patent Document 2] Japanese Patent Laid-Open Publication No. 2004-132106

### DISCLOSURE OF THE INVENTION

### Problems to be Solved by the Invention

However, the waterproof film forming method described in Patent Document 1 requires that drums or tanks separately containing the main component and its curing agent, a motor-driven gear pump and accompanying controllers be transported to and installed at the site where waterproofing will be performed. The method also requires that if an electrical power source and a driving power source such as a compressor are available at the site where waterproofing will be performed, necessary procedures to use them be taken, and if not, the power sources be separately transported and installed and connect the spouting gun module to the gear pump by pressure hoses. For these reasons, the method is much ineffective in waterproofing relatively small areas, such as porches.

In contrast, the waterproof film forming method described in Patent Document 2 is suitable for waterproofing small areas, as in caulking. However, the method requires frequent replacement of the cartridges and is much ineffective when applied in waterproofing moderately large areas, such as porches. The area that can be waterproofed in a single round may be increased by increasing the size of the cartridge so that it can contain increased volumes of the main component and its curing agent. However, the large container considerably adds to the weight and volume of the spouting gun module, making it difficult for an operator to hold the module during operation.

In light of the above-described conventional problems, it is an object of the present invention to provide a waterproof film forming method and an apparatus that can effectively apply a high-quality waterproof urethane film in a short period of time.

### Means for Solving the Problems

To achieve the above-described object, the method of the present invention for forming a waterproof film includes: providing a main component container that contains a main component for forming a waterproof film and discharges the main component as a piston is pushed, and a curing agent container that contains a curing agent for the main component and discharges the curing agent as another piston is pushed, the containers being encased in a pair of retainer cases arranged in a parallel arrangement, respectively; pushing the pistons for the main component container and the curing agent container in a synchronized manner by a single, compressed air-driven cylinder device that is arranged adjacent to the pair of retainer cases; through respective supply hoses, feeding the discharged main component and the curing agent to a spouting gun module that is held by an operator and supplied with compressed air; mixing the main component and the curing agent in a static mixer unit in the spouting gun module; and blowing the mixture with the flow of compressed air onto an object to be waterproofed to form a waterproof film.

According to this method, the main component container and the curing agent container are separate containers that can be easily handled by the operator even when the capacity of each container is increased to as much as several kilograms for waterproofing an area as large as a porch or the like. The containers are encased in the retainer cases, and a compressed air source that has been brought nearby is used to operate the cylinder device to discharge the main component and the curing agent from the respective containers. Through the supply hoses, the discharged main component and curing agent are fed to the spouting gun module held by the operator. In this manner, the operator can effectively waterproof the entire surface of a porch or the like by simply operating the lightweight spouting gun module. In addition, the compressed air source may be used as the sole power source. Furthermore, the method can apply a high-quality waterproof film and can be used to effectively waterproof a porch or the like in a short period of time since the mixture of the main component and the curing agent, propelled by the flow of compressed air, is blown onto an object to be waterproofed.

The apparatus of the present invention for forming a waterproof film includes: a) a main component container that contains a main component for forming a waterproof film and discharges the main component as a piston is pushed; b) a curing agent container that contains a curing agent for the main component and discharges the curing agent as another piston is pushed; c) a main discharge unit including a pair of retainer cases arranged in a parallel arrangement for encasing the main component container and the curing agent container, respectively, and a single, compressed air-driven cylinder device arranged adjacent to the pair of retainer cases for pushing the pistons for the main component container and the curing agent container in a synchronized manner to discharge the main component and the curing agent; d) a spouting gun module that is held by an operator including a static mixer unit into which the main component and the curing agent discharged from the main discharge unit are fed through supply hoses, the static mixer unit mixing the fed main component and the curing agent and discharging the resulting mixture; and e) a compressed air source for supplying compressed air to the main discharge unit.

This construction makes it possible to perform the above-described waterproof film forming method and to effectively waterproof a porch or the like in a short period of time by bringing the following to the site where the waterproofing will be performed: the compressed air source, the main discharge unit, the spouting gun module, and a particular number of the main component containers and the curing agent containers required to waterproof the intended area. The apparatus for forming the waterproof film may also be used when it is desired to mix the main component and the curing agent and discharge for applying the mixture to the surface to be waterproofed.

The spouting gun module may include an air spout passage to which compressed air is supplied from the main discharge unit through an air hose and by which the compressed air is spouted from a periphery of a discharge port of the static mixer unit toward a spout orifice of the spouting gun module. In this manner, a high-quality waterproof film can be formed since the mixture of the main component and the curing agent propelled by the spouting air stream is blown.

The spouting gun module may be include an air control unit arranged in the main discharge unit for controlling the cylinder device, then compressed air may be supplied to the spouting gun module from the main discharge unit through an air hose while, by pulling a trigger of the spouting gun module, being supplied through a control air hose to the air control unit, or the compressed air may be fed to an air spout passage while being supplied through the control air hose to the air control unit. In this manner, waterproofing can be performed by the simple action of pulling the trigger of the spouting gun module. In addition, the apparatus can be controlled by the compressed air source alone and the waterproofing can be effectively performed without requiring separate power sources. This further increases the efficiency of waterproofing.

Furthermore, the air control unit may include an air limit switch for detecting a most extended position and a most retracted position of the cylinder device so as to switch the air passage; a switching valve that can switch the cylinder device into three positions of neutral, extended and retracted; and a sequencer circuit device for controlling the switching valve. In this manner, the operation of the cylinder device can be controlled in such a manner that it extends only while the trigger is pulled and once extending to the most extended position, it starts to retract whether the trigger is pulled or not and continues to retract to the most retracted position, where it stays in a stand-by state.

### BRIEF DESCRIPTION OF THE DRAWINGS

FIG. 1 is an overall schematic diagram of a waterproof film forming apparatus in one embodiment of the present invention;

FIG. 2 is a front view of a spouting gun module of the waterproof film forming apparatus;

FIG. 3 is a partial cross-sectional front view showing key elements of the spouting gun module;

FIG. 4A and FIG. 4B show a main discharge unit of the waterproof film forming apparatus in a longitudinal cross-sectional view (FIG. 4A) and in a side view (FIG. 4B); and

FIG. 5 is a diagram showing air control circuits of the main discharge unit.

### BEST MODE FOR CARRYING OUT THE INVENTION

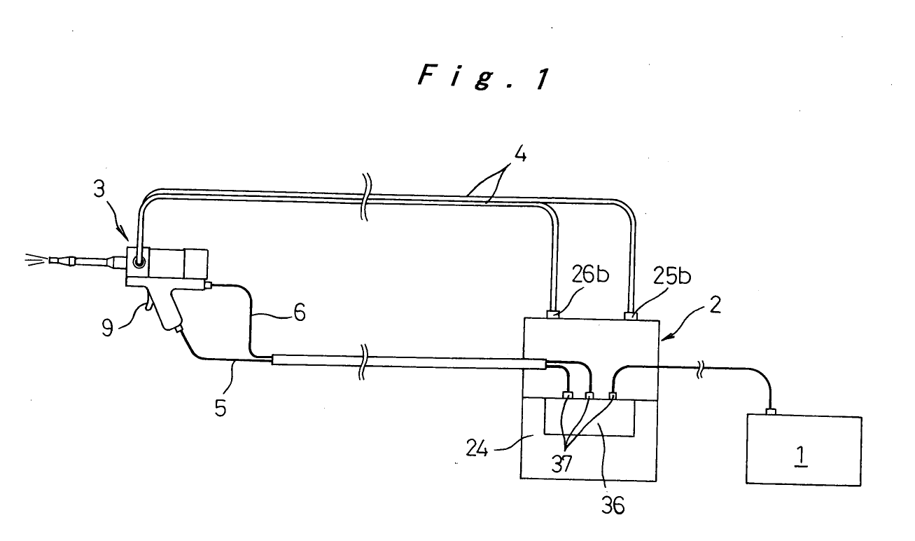

One embodiment of the waterproof film forming method and apparatus of the present invention will now be described with reference to FIGS. 1 through 5.

Referring to FIG. 1, reference numeral 1 denotes a compressed air source, which is preferably a small, internal-combustion engine driven air compressor commonly used in a wide range of civil engineering and construction sites. Reference numeral 2 denotes a main discharge unit as a key element of the present invention, to which compressed air is supplied from the compressed air source 1. Reference numeral 3 denotes a spouting gun module designed to be held by an operator during the operation of the apparatus. The spouting gun module 3 is connected to the main discharge unit 2 by two supply hoses 4 for supplying the main component and the curing agent, an air hose 5 for supplying compressed air (for spouting purpose) from the main discharge unit 2 to the spouting gun module 3, and a control air hose 6 for supplying compressed air (for control purpose) from the spouting gun module 3 to the main discharge unit 2.

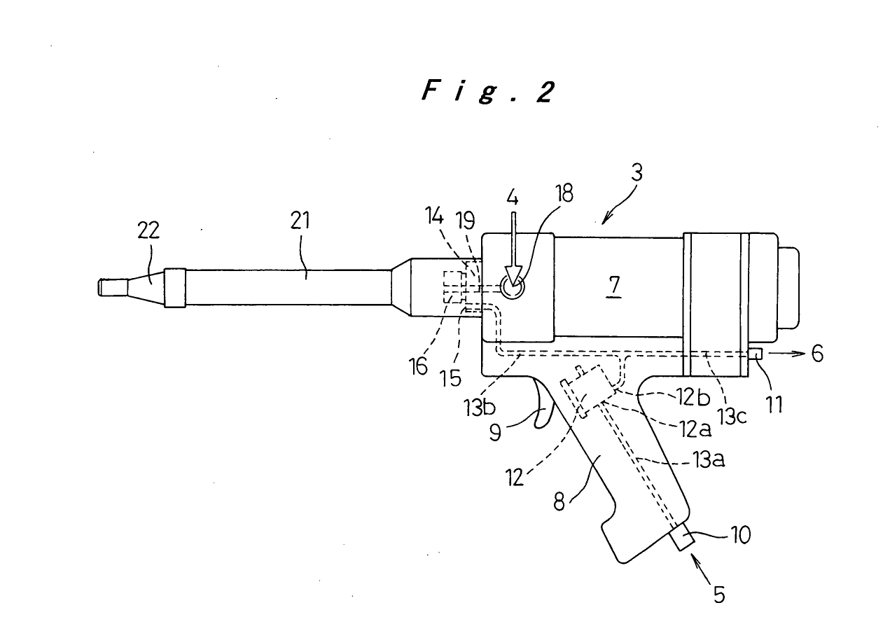

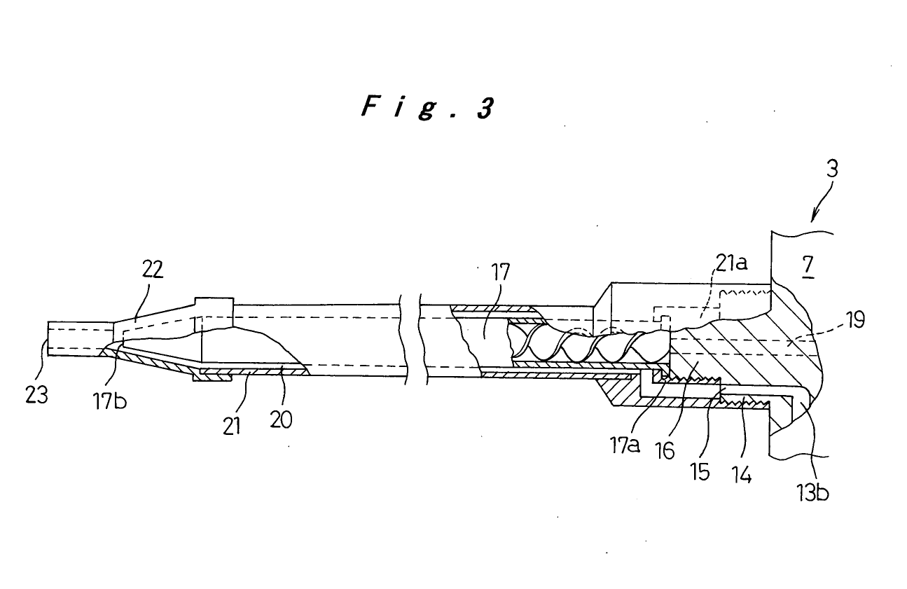

The spouting gun module 3 has essentially the same construction as that described in Japanese Patent No. 3248554 (Patent Document 1). FIGS. 2 and 3 are referred to first. As shown in FIG. 2, the spouting gun module 3 includes a gun body 7 and a handle 8 projecting from the front and lower part of the gun body 7 for balancing the weight of the spouting gun module 3. A trigger 9 is arranged at the upper front face of the handle 8. The handle 8 also includes an air connector 10 at its lower end for connecting an air hose 5. A control air connector 11 for connecting a control air hose 6 is arranged at the lower rear face of the gun body 7. The handle 8 further includes a valve 12 that is opened or closed by the trigger 9. The inlet 12a of the valve 12 is connected to the air connector 10 through an air passage 13a. The outlet 12b of the valve 12 is connected, through an air passage 13b, to a spout outlet 15 that opens at the periphery of the front face of a fixing boss 14 that projects from the front end of the gun body 7. The outlet 12b is also connected to the control air connector 11 through a branched air passage 13c branched from the air passage 13b.

Projecting from the center of the front face of the fixing boss 14 arranged at the front end of the gun body 7 is a mount projection 16, to which a static mixer unit 17 is fastened by screwing at its base portion 17a. Within the static mixer unit 17 are a series of stationary screw guides that mix liquids as they pass through the static mixer unit 17 from the base portion 17a to a discharge port 17b at the tip of the static mixer unit 17, from which the uniform mixture of the liquids is discharged. A connection port 18 for connecting the supply hose 4 is formed on each side of the front end portion of the gun body 7. The two connection ports 18 each communicate with the base portion 17a of the static mixer unit 17 through a liquid supply passage 19.

An air-spouting cylinder 21 is placed over the static mixer unit 17 from the tip-side to define a tubular air passage 20 on the periphery of the static mixer unit 17. The air-spouting cylinder 21 is fastened by screwing to the periphery of the fixing boss 14 at its base portion 21a. The spout outlet 15 in the periphery of the front face of the fixing boss 14 communicates with the tubular air passage 20. Fastened by screwing to the tip portion of the air-spouting cylinder 21 is a spout mouthpiece 22 that covers the discharge port 17b of the static mixer unit 17 and spouts compressed air from a periphery of the discharge port 17b substantially in the direction of discharging, so as to combine the mixture with the compressed air for spouting from a spout orifice 23 at the tip of the spout mouthpiece 22.

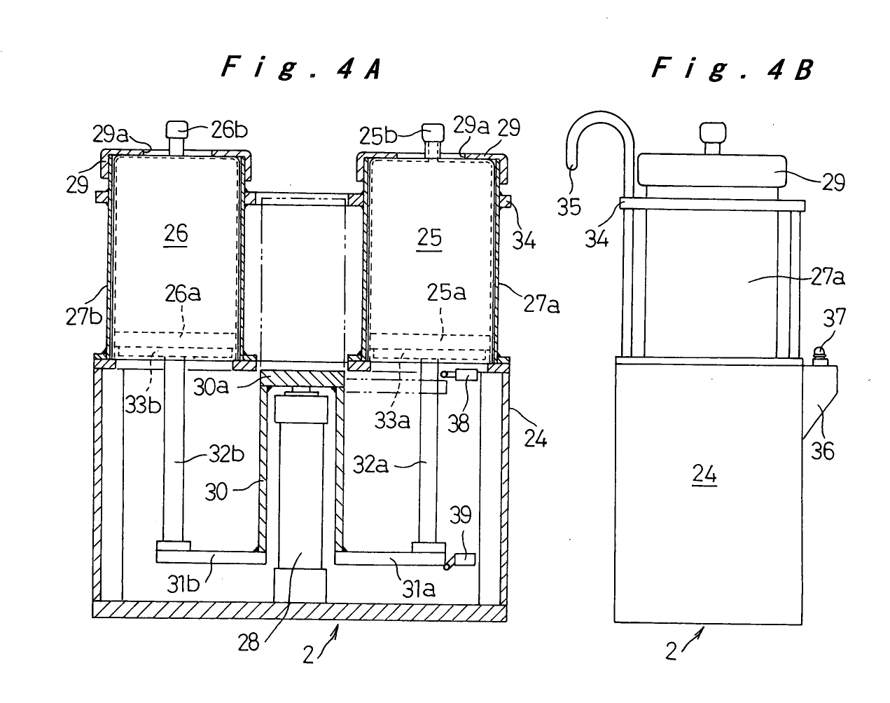

Referring to FIGS. 4A and 4B, the main discharge unit 2 includes a body frame 24 and a pair of spaced-apart retainer cases 27a, 27b that are arranged on the body frame 24 in a parallel arrangement. The retainer cases 27a, 27b encase a main component container 25 for containing the main component for forming a waterproof film and a curing agent container 26 for containing the curing agent for the main component, respectively. The main component container 25 and the curing agent container 26 discharge the main component and the curing agent, respectively, as pistons 25a, 26a are pushed. A single cylinder device 28, driven by compressed air, is arranged in the body frame 24 for pushing the pistons 25a, 26a for the main component container 25 and the curing agent container 26 in a synchronized manner.

The retainer cases 27a, 27b have open tops for putting in and taking out the main component container 25 and the curing agent container 26, respectively. The open tops of the retainer cases 27a, 27b are each closed by a removable lid 29. At the center of each lid 29 is an opening 29a through which an outlet 25b of the main component container 25 or an outlet 26b of the curing agent container 26 extends upward. The outlets 25b, 26b are connected to the respective supply hoses 4.

An inverted cup-like elevator member 30 is joined at its bottom 30a to the tip of the piston rod of the cylinder device 28. Linking members 31a, 31b extend from the lower end of the elevator member 30 to either side of the elevator member 30. Vertically arranged at the respective ends of the linking members 31a, 31b are elevator shafts 32a, 32b, at the upper ends of which provided are push plates 33a, 33b that abut and push up the pistons 25a, 26a of the main component container 25 and the curing agent container 26, respectively.

Reference numeral 34 denotes a reinforcing plate that joins the retainer cases 27a, 27b at their top portions. Reference numeral 35 denotes a transport handle jointed both to the upper end of the body frame 24 and to the reinforcing plate 34. Arranged on the bottom surface of the body frame 24 are transport wheels (not shown) and securing legs (not shown). Arranged at the upper part of one side of the body frame 24 is an air control unit 36, on top of which provided are three air connectors 37. The first, the second and the third of the air connectors 37 are connected to the compressed air source 1, the air hose 5 and the control air hose 6, respectively.

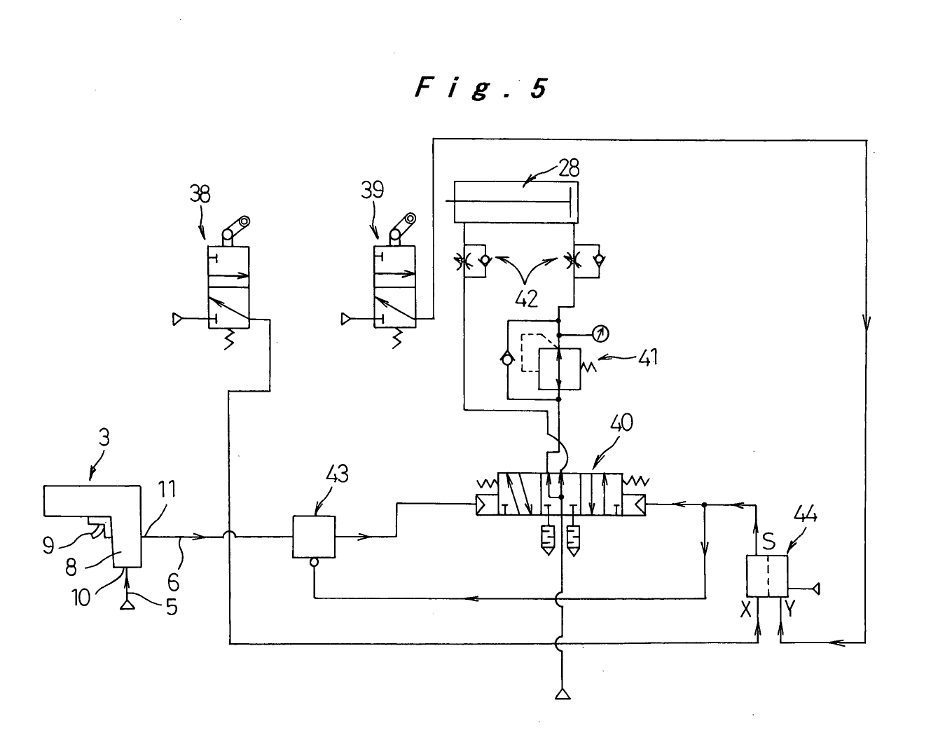

Referring now to FIG. 5, the circuit arrangement of the air control unit 36 is described. Air limit switches 38, 39 are arranged within the body frame 24 to detect the most extended position and the most retracted position of the cylinder device 28 and switch the air passage accordingly. The air control circuit is designed to supply compressed air to the cylinder device 28 via an air-switching valve 40, a reverse regulator 41, and a speed controller 42. The air-switching valve 40 can be switched among the following three positions: neutral, extended and retracted. The compressed air from the control air hose 6 is connected to the extended-side port of the air-switching valve 40 via a sequencer circuit device 43 that serves as an NOT device. The compressed air fed by the activation of the air limit switches 38, 39 is fed to a sequencer circuit device 44 that serves as a memory device, from which the compressed air is fed to the retracted-side port of the air-switching valve 40 via the sequencer circuit device 44. The compressed air also branches and the branch is connected to the NOT terminal port of the sequencer circuit device 43 that serves as an NOT device.

When the trigger 9 of the spouting gun module 7 is pulled while the air-switching valve 40 is in the neutral position and the cylinder device 28 is not moving with compressed air fed on both sides of its piston, compressed air is supplied to the extended-side port of the air-switching valve 40 via the control air hose 6 and the sequencer circuit device 43, causing the air-switching valve 40 to switch to the extended position. As a result, the cylinder device 28 extends. When the trigger 9 is released during the extension of the cylinder device 28, the air-switching valve 40 returns to the neutral position, causing the cylinder device 28 to stop extending further. Pulling the trigger 9 again causes the cylinder device 28 to extend again.

Once the cylinder device 28 extends to its most extended position, the air limit switch 38 is activated to supply the compressed air to the sequencer circuit device 44, from which the compressed air is supplied to the retracted-side port of the air-switching valve 40. This state is memorized, so that the compressed air is continuously supplied to the retracted-side port of the air-switching valve 40 and the cylinder device 28 continues to retract after the air limit switch 38 has returned to the non-activating position. During this, compressed air is also supplied to the NOT terminal port of the sequencer circuit device 43, shutting down the sequencer circuit device 43, so that compressed air will not be supplied to the extended-side port of the air-switching valve 40 if the trigger 9 remains pulled.

Once the cylinder device 28 retracts to the most retracted position, the air limit switch 39 is activated to supply compressed air to the sequencer circuit device 44, shutting off the supply of compressed air from the sequencer circuit device 44 to the retracted-side port of the air-switching valve 40. As a result, the air-switching valve 40 returns to its neutral position and stays there in a stand-by state. Accordingly, the operation of the cylinder device 28 can be controlled in such a manner that it extends only while the trigger 9 is pulled and once extending to the most extended position, it starts to retract whether the trigger 9 is pulled or not and continues to retract to the most retracted position, where it stays in a stand-by state.

When the above-described waterproof film forming apparatus is used to waterproof a porch or the like, the compressed air source 1, the main discharge unit 2, the spouting gun module 3, and a particular number of the main component containers 25 and the curing agent containers 26 required to waterproof the intended area are brought to the site where the waterproofing will be performed. For example, when the main component container 25 and the curing agent container 26 contain 2.5 kg of the respective liquid agents, a 1 mm-thick waterproof film can be formed over 5 m² area. Thus, a single main component container 25 and a single curing agent container 26 are enough to waterproof a typical porch about 4 to 5 m² in area. Since it takes about 3 minutes to spout out the entire contents of the main component container 25 and the curing agent container 26, waterproofing of a porch 5 m² or less in area can be finished in about 3 minutes.

The compressed air source 1 is operated with the compressed air source 1 connected to the main discharge unit 2 and the main discharge unit 2 connected to the spouting gun module 3 via the air hose 5 and the control air hose 6. The main component container 25 and the curing agent container 26 are placed in the respective retainer cases 27a, 27b of the main discharge unit 2 and the lids 29 are closed. The outlets 25b, 26b of the main component container 25 and the curing agent container 26 are connected to the connection port 18 of the spouting gun module 3 by supply hoses 4.

With all the preparations done, the operator, holding the spouting gun module 3, pulls the trigger 9 to spout the compressed air from the spout orifice 23 and activate the cylinder device 28, which pushes the pistons 25a, 26a of the main component container 25 and the curing agent container 26 in a synchronized manner, so that the discharged main component and curing agent are fed to the spouting gun module 3 through the respective supply hoses 4. The main component and the curing agent are uniformly mixed in the static mixer unit 17 and the mixture is combined with the flow of the compressed air and spouted from the spout orifice 23. Thus, the operator can operate the spouting gun module 3 to uniformly blow the mixture onto the surface to be waterproofed, such as porch floors, to form a high-quality waterproof film. In this manner, high-quality waterproofing of porches or the like can be effectively performed in a short period of time.

When waterproofing is finished before the main component container 25 and the curing agent container 26 are empty, the operator will pull out the main component container 25 and the curing agent container 26 from the respective retainer cases 27a, 27b and pull the trigger 9 of the spouting gun module 3 to cause the cylinder device 28 to extend to the most extended position and then retracts to the most retracted position where it stays in a stand-by state. Similar operation will be repeated at the next site to perform waterproofing. By tightly closing their outlets 25b, 26b, the main component container 25 and the curing agent container 26 transported to the next site can be reused to perform waterproofing.

According to the present embodiment, the main component container 25 and the curing agent container 26 are separate containers that can be easily handled by the operator when the capacity of each container is increased to as much as several kilograms for waterproofing an area as large as a porch or the like. This ensures high operability. In addition, the operator only needs to operate the lightweight spouting gun module 3 that does not incorporate the main component container 25 or the curing agent container 26 and can thus effectively perform waterproofing. Furthermore, the mixture of the main component and the curing agent propelled by the spouting air stream can form a high-quality waterproof film that contains independent bubbles, has a uniform thickness, is permeable to water vapor, but not to water, and has a high adhesive strength.

The operator can simply pull the trigger 9 of the spouting gun module 3 to activate, through the control air hose 6, the air-switching valve 40 of the air control unit 36 arranged in the main discharge unit 2 and to thereby supply the operation air to the cylinder device 28. Thus, not only can the operator perform waterproofing by the simple action of pulling the trigger 9 of the spouting gun module 3, but the apparatus can be controlled by the compressed air source alone and the waterproofing can be effectively performed without requiring separate power sources. This further increases the efficiency of waterproofing.

While the mixture of the main component and the curing agent is propelled by the spouting air stream in the above description of the present embodiment, the mixture of the main component and the curing agent may be discharged and directly applied to the surface to be waterproofed. In addition, while the main component and the curing agent are mixed in equal amounts in the description above, the main component container 25 and the curing agent container 26 having different diameters may be used when it is desired to mix the main component and the curing agent in different proportions.

### INDUSTRIAL APPLICABILITY

According to the waterproof film forming method and apparatus of the present invention, the main component container and the curing agent container are separate containers that can be easily handled by the operator when the capacity of each container is increased in order to waterproof a large area, such as a porch or the like. These containers are encased in the retainer cases, and the compressed air source that has been brought near the apparatus is used to operate the cylinder device to discharge the main component and the curing agent from the respective containers. Through the supply hoses, the discharged main component and curing agent are fed to the spouting gun module held by the operator. This construction enables the operator to perform waterproofing by simply operating the lightweight spouting gun module. Thus, the present invention makes it possible to perform waterproofing in a short period of time and at a low cost and is therefore suitable for waterproofing porches or the like.

1. A method for forming a waterproof film, comprising:
providing a main component container that contains a main component for forming a waterproof film and discharges the main component as a piston is pushed, and a curing agent container that contains a curing agent for the main component and discharges the curing agent as a piston is pushed, the containers being encased in a pair of retainer cases arranged in a parallel arrangement, respectively;
pushing the pistons for the main component container and the curing agent container in a synchronized manner by a single, compressed air-driven cylinder device that is arranged adjacent to the pair of retainer cases;
through respective supply hoses, feeding the discharged main component and the curing agent to a spouting gun module that is held by an operator and supplied with compressed air;
mixing the main component and the curing agent in a static mixer unit in the spouting gun module; and
blowing the mixture with the flow of compressed air onto an object to be waterproofed to form a waterproof film.

2. An apparatus for forming a waterproof film, comprising:
a main component container that contains a main component for forming a waterproof film and discharges the main component as a piston is pushed;
a curing agent container that contains a curing agent for the main component and discharges the curing agent as a piston is pushed;
a main discharge unit comprising a pair of retainer cases arranged in a parallel arrangement for encasing the main component container and the curing agent container, respectively, and a single, compressed air-driven cylinder device arranged adjacent to the pair of retainer cases for pushing the pistons for the main component container and the curing agent container in a synchronized manner to thereby discharge the main component and the curing agent;
a spouting gun module that is held by an operator comprising a static mixer unit into which the main component and the curing agent discharged from the main discharge unit are fed through supply hoses, the static mixer unit mixing the fed main component and the curing agent and discharging the resulting mixture; and
a compressed air source for supplying compressed air to the main discharge unit.

3. The apparatus according to claim 2, wherein the spouting gun module comprises an air spout passage to which compressed air is supplied from the main discharge unit through an air hose and by which the compressed air is spouted from a periphery of a discharge port of the static mixer unit toward a spout orifice of the spouting gun module.

4. The apparatus according to claim 2, wherein the spouting gun module comprises an air control unit arranged in the main discharge unit for controlling the cylinder device, compressed air being supplied to the spouting gun module from the main discharge unit through an air hose while, by pulling a trigger of the spouting gun module, being supplied through a control air hose to the air control unit, or the compressed air being fed to an air spout passage while being supplied through the control air hose to the air control unit.

5. The apparatus according to claim 4, wherein the air control unit comprises: an air limit switch for detecting a most extended position and a most retracted position of the cylinder device so as to switch the air passage; a switching valve that can switch the cylinder device into three positions of neutral, extended and retracted; and a sequencer circuit device for controlling the switching valve.
